(19) United States
(12) Patent Application Publication
(10) Pub. No.: US 2012/0197759 A1
(43) Pub. Date: Aug. 2, 2012

(54) Method for multijurisdictional tax collection

(76) Inventors: Aaron J. Neely, Indianola, IA (US); Jonathan Ruden, Hinton, IA (US)

(21) Appl. No.: 12/931,376

(22) Filed: Jan. 31, 2011

(51) Int. Cl. G06Q 30/00; G06Q 40/00

(52) U.S. Cl. 705/26.41

(57) ABSTRACT

A system for calculating and collecting taxes across different tax jurisdictions. The system receives payment information from an online retailer and uses the information to determine if a sales or use tax is owed. If a tax is owed, the system calculates the amount owed and the proper taxing authority to which the tax must be remitted. Upon determining the appropriate tax to be levied, the system provides a tax invoice to an online purchaser and directs the associated tax payment to the appropriate taxing authority.

### TECHNICAL FIELD

The disclosed embodiments relate generally to a tax collection system and, more particularly, to a multijurisdictional tax collection system for collecting and distributing sales and use tax associated with online sales.

### BACKGROUND

Some geographic regions, like states and countries, have specific, but differing laws requiring the payment of tax associated with the sale and use of various goods and services. For goods purchased online or outside of a particular jurisdiction and later brought into the jurisdiction, the purchaser's “home” jurisdiction often charges a “use” tax. The use tax law allows the jurisdiction to collect taxies on sales made outside of its own jurisdiction. While some buyers intentionally circumvent the payment of tax on purchases by purchasing out of the jurisdiction and then refusing to disclose the purchase, many purchasers are simply unaware of the use tax obligation, how it is calculated, or how or where to pay use taxes. The payment of use tax is mandatory, but given the small amount of tax owed for each transaction and the large number of transactions occurring every day, tracking such purchases and enforcing the payment of use tax is often not economically feasible.

As Internet sales have climbed, geographic tax jurisdictions, such as countries or states, have become interested in collecting use tax on these sales. While it would be in the best interest of states to cooperate with one another by reporting sales made in one state so that use tax may be paid in another, the state use tax laws are different from state to state, making the accurate identification of the purchase of taxable items, the calculation of the appropriate tax and the reporting of use taxes difficult. Such reporting could require different identification, calculation, collection, distribution and reporting procedures to comport with the specific use tax laws of each state.

Understandably, online retailers have been reluctant to try and guess the appropriate jurisdiction to use for the calculation of the use tax on a particular sale, to interpret the use tax law of fifty different states and thousands of different jurisdictions and to collect the tax on behalf of the states, all while avoiding harsh criminal and civil penalties associated with errors in calculating, collecting and distributing the tax. To address these concerns, several states have worked together to create a multi-state agreement known as the Streamlined Sales and Use Tax Agreement. This agreement is an attempt to harmonize state use tax laws to streamline use tax reporting and collection for retailers.

The Streamlined Sales and Use Tax Agreement allows retailers to register with, file returns with, and remit funds to the state taxing authority with jurisdiction over the seller. By agreement, each member state of the Streamlined Sales and Use Tax Agreement conducts, or authorizes every other signatory state to conduct on its behalf, audits of sellers subject to tax regulation by the particular state. The states then share information with one another regarding Internet sales and the identity and location of the purchaser. The states receiving this information calculate sales and use tax for purchasers subject to sales or use tax by the particular state. Sellers use either a certified automated system (CAS) or a certified service provider (CSP) to calculate the amount of tax owed. CAS is software certified under the Streamlined Sales and Use Tax Agreement to calculate the tax imposed by each member jurisdiction on a particular transaction, determine the amount of tax to remit to the appropriate state, and maintain a record of the transaction. The CSP is an agent certified under the Streamlined Sales and Use Tax Agreement to perform a particular seller's sales and use tax function.

Once a seller receives a purchase request from a purchaser, the seller uses the CAS or CSP to immediately determine if the purchaser is subject to sales or use tax in another jurisdiction. If the purchaser is subject to sales or use tax, the seller uses the CAS or CSP to calculate the appropriate sales or use tax associated with the transaction and submit the tax demand to the purchaser, along with the purchase price invoice. Once the purchaser pays the purchase price and the tax, the seller collects the tax and remits the tax to an entity such as the Streamlined Sales Tax Governing Board, along with the transaction details and purchaser identification. The Streamlined Sales Tax Governing Board uses the collected funds and the transaction details to remit the tax to the appropriate state taxing authority governing the purchaser's purchase. One problem associated with the prior art processes for collecting the sales and use tax on online sales is the hardship imposed upon Internet retailers to calculate and collect the appropriate tax for each member state. As the prior art system still imposes a hardship on online retailers calculating and collecting tax, and may subject the online retailer to civil or criminal tax penalties associated with incorrect calculation or collection of sales or use taxes, it has heretofore been difficult to convince online retailers to register for, or participate in, the Streamlined Sales and Use Tax program.

It would, therefore, be desirable to provide a system which abbreviated the time, cost and liability associated with calculating, collecting and remitting sales and use tax information associated with various online sales to the various state taxing authorities. It would be desirable to provide a system for sales and use tax collection that uses information already collected by online retailers in the ordinary course of business. It would further be desirable to provide a system for sales and use tax collection that reduces online retailers' exposure to additional civil and criminal liability associated with the collection of use taxes. By reducing the time, cost and liability associated with multijurisdictional tax collection, and streamlining the reporting process required of Internet retailers, retailers will be more likely to register with the program, provide the required reporting information, and thereby increase the overall payment of sales and use tax associated with online purchases. Given the benefits of the program to taxing authorities, taxing authorities may mandate retailers register with the program.

### SUMMARY OF THE DISCLOSED SUBJECT MATTER

The present invention includes a method for collecting information relating to a multijurisdictional sale between a seller and purchaser via a computer network. The payment information and purchaser identification is provided from the seller to a tax collector. Using the payment information, an appropriate tax assessment is calculated. A tax collector provides the purchaser with an invoice for the appropriate tax, based on the online sales transaction. As the sellers provide payment information, the taxing authority having jurisdiction over the purchaser collects the payment information and invoices the purchaser for the appropriate outstanding tax liability.

### BRIEF DESCRIPTION OF THE DRAWINGS

The present invention will now be described, by way of example, with reference to the accompanying drawings in which:

FIG. 1 is a block diagram of the system architecture in accordance with one embodiment;

FIG. 2 is a block diagram of the purchase webpage of a website used in accordance with one embodiment;

FIG. 3 is a block diagram of the system architecture of a single transaction in accordance with one embodiment;

FIG. 4 is a block diagram of a prior art system for data and funds transfer in association with payment of sales and use taxes associated with an online transaction;

FIG. 5 illustrates a block diagram of the flow of data and funds in association with payment of sales and use taxes for an online transaction in accordance with one embodiment.

FIG. 6 illustrates a block diagram of the flow of data and funds in association with payment of sales and use taxes for an online transaction in accordance with an alternative embodiment;

FIG. 7 illustrates a block diagram of the flow of data and funds in association with payment of sales and use taxes for an online transaction in accordance with an alternative embodiment;

FIG. 8 illustrates a block diagram of the flow of data and funds in association with payment of sales and use taxes for an online transaction in accordance with an alternative embodiment;

FIG. 9 illustrates a block diagram of the flow of data and funds in association with payment of sales and use taxes for an online transaction in accordance with an alternative embodiment;

FIG. 10 illustrates a block diagram of the flow of data and funds in association with payment of sales and use taxes for an online transaction in accordance with an alternative embodiment;

FIG. 11 illustrates a block diagram of the flow of data and funds in association with payment of sales and use taxes for an online transaction in accordance with an alternative embodiment;

FIG. 12 illustrates a block diagram of the flow of data and funds in association with payment of sales and use taxes for an online transaction in accordance with an alternative embodiment;

FIG. 13 illustrates a block diagram of the flow of data and funds in association with payment of sales and use taxes for an online transaction in accordance with an alternative embodiment;

FIG. 14 illustrates a block diagram of the flow of data and funds in association with payment of sales and use taxes for an online transaction in accordance with an alternative embodiment;

FIG. 15 illustrates a block diagram of the flow of data and funds in association with payment of sales and use taxes for an online transaction in accordance with an alternative embodiment;

FIG. 16 illustrates a block diagram of the flow of data and funds in association with payment of sales and use taxes for an online transaction in accordance with an alternative embodiment;

FIG. 17 illustrates a block diagram of the flow of data and funds in association with payment of sales and use taxes for an online transaction in accordance with an alternative embodiment;

FIG. 18 illustrates a block diagram of the flow of data and funds in association with payment of sales and Use taxes for an online transaction in accordance with an alternative embodiment;

FIG. 19 illustrates a block diagram of the flow of data and funds in association with payment of sales and use taxes for an online transaction in accordance with an alternative embodiment;

FIG. 20 illustrates a block diagram of the flow of data and funds in association with payment of sales and use taxes for an online transaction in accordance with an alternative embodiment;

FIG. 21 illustrates a block diagram of the flow of data and funds in association with payment of sales and use taxes for an online transaction in accordance with an alternative embodiment;

FIG. 22 illustrates a block diagram of the flow of data and funds in association with payment of sales and use taxes for an online transaction in accordance with an alternative embodiment; and

FIG. 23 illustrates a block diagram of the flow of data and funds in association with payment of sales and use taxes for an online transaction in accordance with an alternative embodiment.

### DETAILED DESCRIPTION OF THE DRAWINGS

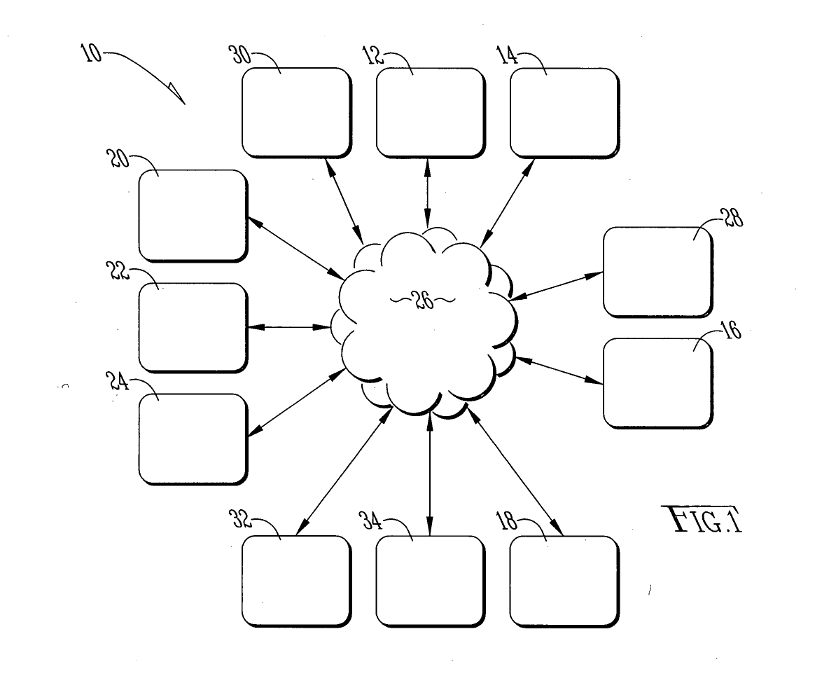

As shown in FIG. 1, a tax collection system (10) is provided to allow various state authorities (12) and (14) to obtain sales and use taxes associated with purchasers (16), (18) and (20) from various retailers (22) and (24) made over a electronic communication system (26), such as a telephony system such as that known in the art or a global computer network, such as the Internet. When a purchaser (16) wishes to execute a purchase order for the purchase of a good or service from a seller (22), the purchaser (16) accesses the system (26) to provide the retailer (22) with payment, purchaser identification, information related to the good or service being purchased, and delivery information. This may entail the purchaser (16) calling in a catalog order with a telephone or entering the order into a webpage associated with a website. In response, the retailer (22) provides the purchase to the purchaser (16). The purchase may be a good or service to be delivered to the purchaser (16) or to be provided to a third party (28) designated by the purchaser (16). The retailer (22) provides information associated with the purchase and purchaser identification to a tax collector (30) that determines the appropriate state tax collection authorities (32) or (34) having jurisdiction over collection of sales or use tax of the purchaser (16). The tax collector (30) calculates a tax assessment based upon the state and local regulations governing the purchase and invoices the purchaser (16) for the tax assessment. Local regulations may include local option sales tax and the like. The purchaser (16) then pays the tax assessment to the appropriate state tax collection authority (32). In the prior art, the retailer (22) would collect both the purchase price and the associated tax. In the preferred embodiment of the present invention, the retailer (22) collects the purchase price, while the tax collector (30) collects the associated tax.

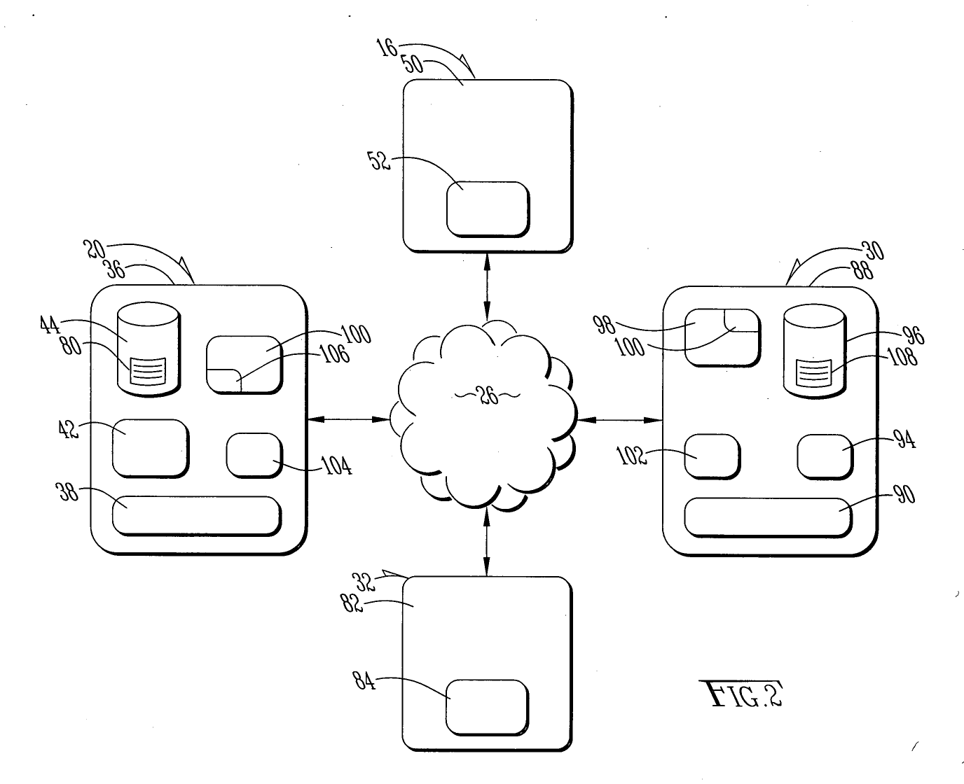

FIG. 2 is a block diagram of the architecture of the system (10) in accordance with one embodiment. As illustrated in FIG. 2, a server (36) associated with the retailer (22) is provided with a front end server (38), a network interface (40), a central processing unit (42) and database (44). Conventional features, such as firewalls, load balancers, application servers, failover servers, site management tools, as well as additional conventional and known features are not shown to allow clearer illustration of the novel features of the system. The retailer (22) may be an online store, an online service provider or a combination thereof, or any desired kind of retailer of goods or services.

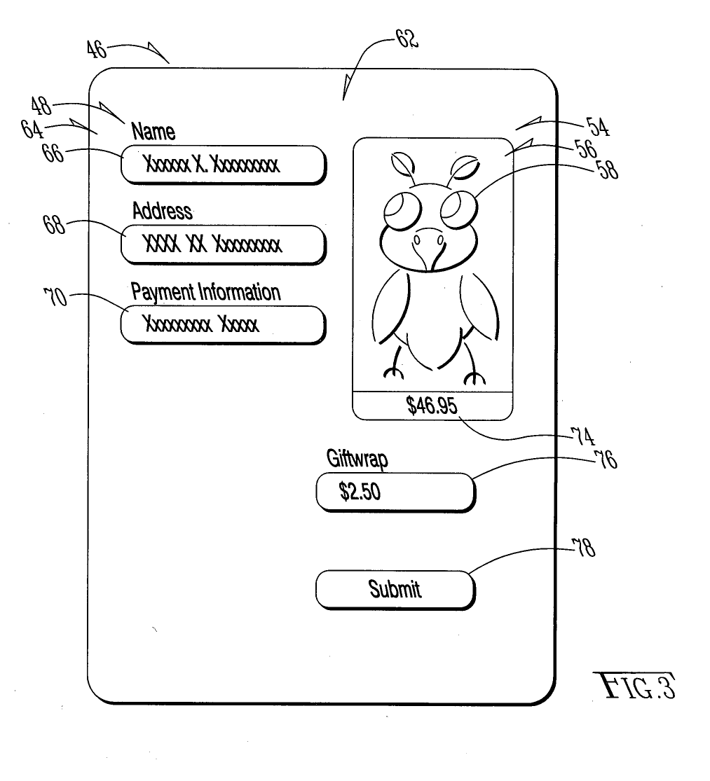

When the purchaser (16) wishes to make a purchase, the purchaser (16) uses a client (50) to execute a browser (52) and connect to the server (38) via the system (26). The purchaser (16) accesses the retailer's website via the system (26) and provides the retailer (22) with information (48) regarding a purchase order. As used herein, the term “website” means any system providing content via the Internet or via internet capable protocols including, but not limited to http and https protocols. In general, functions described herein as being provided on the server may also be performed on the client side as appropriate. Alternatively, the purchaser (16) may provide the information (48) telephonically, via electronic mail, via facsimile or by any method of communication. (FIGS. 2-3)

The system (26) is typically the Internet, but may also be any network, including but not limited to; a LAN, an MAN, a WAN, a mobile, wire or wireless network, a private network or a virtual private network. Although a single client (50) and server (36) are shown, it is to be understood that millions of clients (50) and servers (36) may be supported and can be in communication with one another at any given time. If desired, the retailer (22) may use multiple servers at various locations to service purchasers (16), (18) and (20). The client (50) may include a variety of different computing devices. Examples of computing devices are personal computers, digital systems, personal digital systems, mobile phones, smart phones, tablet devices or laptop computers. As it would be obvious to one of ordinary skill in the art, the present invention is not limited to the foregoing devices.

The website (46) presents the purchaser (16) with an interface (54) which provides the purchaser (16) with purchase options (56) (FIGS. 1-3). The interface (54) displays the website (46) via a secure Secure Socket Layer (SSL), or similar security protocol to prevent interception of the information (48) associated with the transaction. The purchase options (56) may include goods (58), services (60), or a combination thereof. Once the purchaser has selected from the purchase options (56), the interface (54) prompts the purchaser (16) to provide information relating to the purchase order (62). The purchase order (62) may include purchaser identification (64), such as the purchaser's name (66), address (68) and payment information (70). This information (70) is provided by the purchaser (16) into fields displayed by the interface (54). Alternatively, the retailer (22) may have the purchaser identification (64) stored in the database (44) from the previous transaction, in which case the server (38) accesses the information (64) from the database (44) and associates a purchaser identification (64) with a purchase order (62). The purchaser (16) also selects the desired goods (58) and/or services (60) to be purchased. The interface (54) displays price information (74) and (76), along with an image of the goods (58) and services (60). Once the purchase order (62) is complete, the purchaser (16) may select a submit button (78) displayed by the interface (54), or similar confirmation to execute the purchase order (62).

Once a purchaser (16) selects the submit button (78), the server (36) stores the purchase information in a database (44). Preferably, the retailer (22) creates a purchaser account (80) which stores the purchaser account information in the database (44). The purchaser account (80) includes a record of purchases made by the purchaser (16), including, the purchase order (62) and purchaser identification (64). The purchaser (16) may pay for the purchase order (62) by any known means, including, but not limited to, check, credit card, debit card, ACH processing, or physically delivered funds such as cash.

To facilitate calculation of the tax owed on multijurisdictional sales, a state tax collection authority (32) provides state-specific tax information to the tax collector (30) regarding tax calculations based upon various state laws and jurisdictions within the particular state associated with the state tax collection authorities (32) and (34). (FIGS. 1-2). As illustrated in FIG. 2, the state tax collection authority (32) uses a client (82) to execute a browser (84) that connects via the system (26) to a server (88) associated with the tax collector (30). The tax collector (30) may be a state agency, a certified service provider, such as an agent used by the tax collection agency to perform the retailer's (22) and (24) sales and use tax functions, a certified automated system, such as software certified by the retailers (22) and (24) to calculate the tax imposed by each jurisdiction on a transaction, determine the amount of tax to remit to the appropriate state, and maintain a record of the transaction, or an independent third party, authorized by the state tax collection authorities (32) and (34) to perform tax calculation and/or collection functions.

The server (88) is provided with a front end server (90), a network interface (92), a central processing unit (CPU) (94), a database (96) and system software (98). Although only a single state tax collection authority (32) and tax collector (30) are, shown, it is to be understood that dozens of state tax collection authorities (32), hundreds of national tax collection authorities, and millions of servers (88) operated by multiple tax collectors (30) may be in communication with on another across the system (26) at any given time. The state tax collection authority (32) may provide information regarding tax rates, jurisdictions and exceptions to the taxing authority directly to the tax collector (30), or may provide the information to the server (88) via the browser (84).

Alternatively, the tax collector (30) may obtain or seek out updates to the tax laws as they become available to allow the tax collector (30) to provide accurate tax calculation, collection and remittance. Upon receipt, of payment information from a retailer, the tax collector (30) uses the tax law information to determine the appropriate tax assessment. Alternatively, the tax collector (30) may use the tax law information to create tax assessment and collection software (100) customized to calculate tax assessments for various jurisdictions, and store this software (100) on the server (88).

As an alternative, the tax collector (30) may also provide the software (100) to the retailer (22). The software (100) may be provided through a network interface (102) associated with the server (88) via the system (26) to a network interface (104) associated with the retailer server (36). The retailer (22) may associate the tax collection software (100) with server software (106) to allow the retailer (22) to calculate the appropriate tax assessment, using information associated with the purchase information or purchase account (80) stored on the database (44).

When a purchaser (16) makes a purchase from the retailer (22) as described above, the retailer (22) uses the system software (106) to transmit the name (66) of the purchaser (16), and any other desired purchaser identification (64) and payment information (70) via the network interface (104) and system (26) to the network interface (102) of the server (88) associated with the tax collector (30). This can be accomplished directly by the retailer (22), with the system software (106) or with a database data export function, such as those known in the art. Upon receipt of this information, the tax collector (30) uses the address (68) associated with the purchase order (62) and stored on the database (44) to determine if the purchase order (62) is subject to a tax assessment to the state tax collection authorities (32) and (34). If a tax assessment is due, the tax collector (30) uses additional information associated with the purchase order (62), such as the payment information (70) to calculate a tax assessment. Alternatively, the retailer (22), or more preferably the tax collector (30), use the tax collection software (100) to automate the tax assessment calculation of the appropriate tax assessment, based upon the information associated with the purchase order (62) collected by the retailer (22).

Depending on the requirements of the state tax collecting authorities (32) and (34), the tax collector (30) may either store the tax assessment information within a tax assessment account (108) stored in the database (96), or send the tax assessment directly to the client (82) associated with the state tax collection authority (32). Alternatively the tax collector (30) may make the information available on a secure website, or periodically send the information to the state tax collecting authority (32). As another alternative, the state tax collecting authority (32) and (34) may request the tax collector (30) provide a purchaser (16) an invoice for the tax assessment. The tax collector (30) may either send this invoice directly to the purchaser (16) or forward the tax assessment invoice to the purchaser (16) electronically via the system (26).

Upon receipt, of the tax assessment invoice, the purchaser (16) may either remit payment directly to the tax collector (30) or state tax collecting authority (32) or (34), or electronically via the system (26). If the tax collector (30) receives the payment associated with the tax assessment invoice directly from the purchaser (16), the tax collector (30) may, as agreed upon with the state tax collecting authority (32) or (34), store the payment, remit the payment directly to the appropriate state tax collecting authority (32) or (34), remit payment funds periodically to the state tax collecting authorities (32) and (34), or withhold a percentage portion of such funds in return for providing the collection and remittance functions, and submit the remaining funds to the appropriate state tax collection authorities (32) and (34).

As an alternative, the tax collector (30) upon receiving the purchase information from the retailer (22) may submit the tax assessment information directly to the state tax collection authority (32) that may, in turn, invoice the purchaser (16) directly. Alternatively, the state tax collection authority (32) may require the tax assessment invoice be paid as part of the purchaser's quarterly, annual or other periodic tax return required to be filed by the state tax collection authority (32).

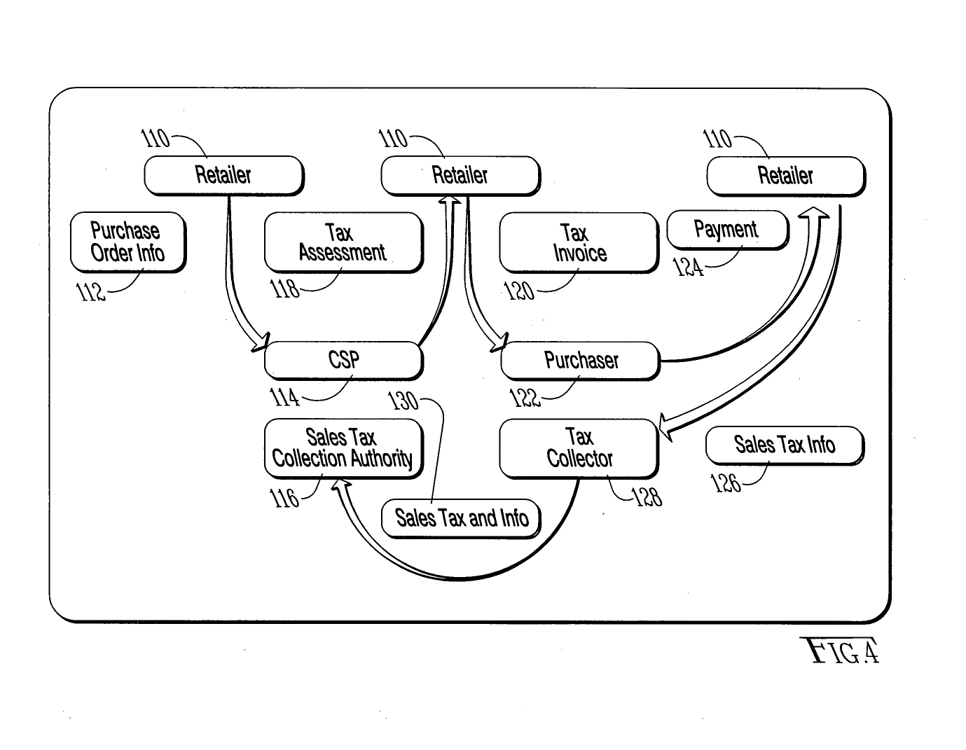

As shown in FIG. 4, prior art proposals for collecting sales and use tax for online sales have focused on the retailer (110) collecting the purchase price and tax from the purchaser (122) at the same time. As shown, once a retailer (110) receives a purchase order (62), the retailer (110) sends the purchase order information (112) to a certified service provider (CSP), accountant or other authorized calculation authority (114), which is an agent certified under an agreement between multiple state tax collecting authorities (116). The certified service provider (114) calculates the tax assessment based upon jurisdiction and tax rates issued by the states associated with the state tax collection authorities (116) and returns the tax assessment (118) associated with the purchase order information (112) to the retailer (110). The retailer (110) then provides an invoice to a purchaser (122). The invoice contains both the purchase price and the tax assessment (120). The purchaser (122) then makes a payment (124) of the entire amount back to the retailer (110). The retailer (110) retains the purchase price and remits the tax (126) to a tax collector (128), such as the Streamline Sales Tax Governing Board, that thereafter, remits the sales tax information to the appropriate state, tax collection authority (116) based upon the information supplied to the tax collector (128) by the retailer (110). The sales tax and information (130) may either be the same sales tax information (126) supplied by the retailer (110) to the tax collector (128) or may be reduced by an amount sufficient to compensate the tax collector (128) for the processing of the sales tax and information (126).

The downside associated with this prior art system is that it makes the retailer (110) liable for collecting and redistributing the tax (126). Serious civil and criminal penalties for the mishandling of tax and the requirement that retailers (110) obtain separate ongoing authorization from each individual state tax collection authority (116), have made retailers (110) resistant to collect sales tax on Internet purchases for the benefit of state tax collection authorities (116).

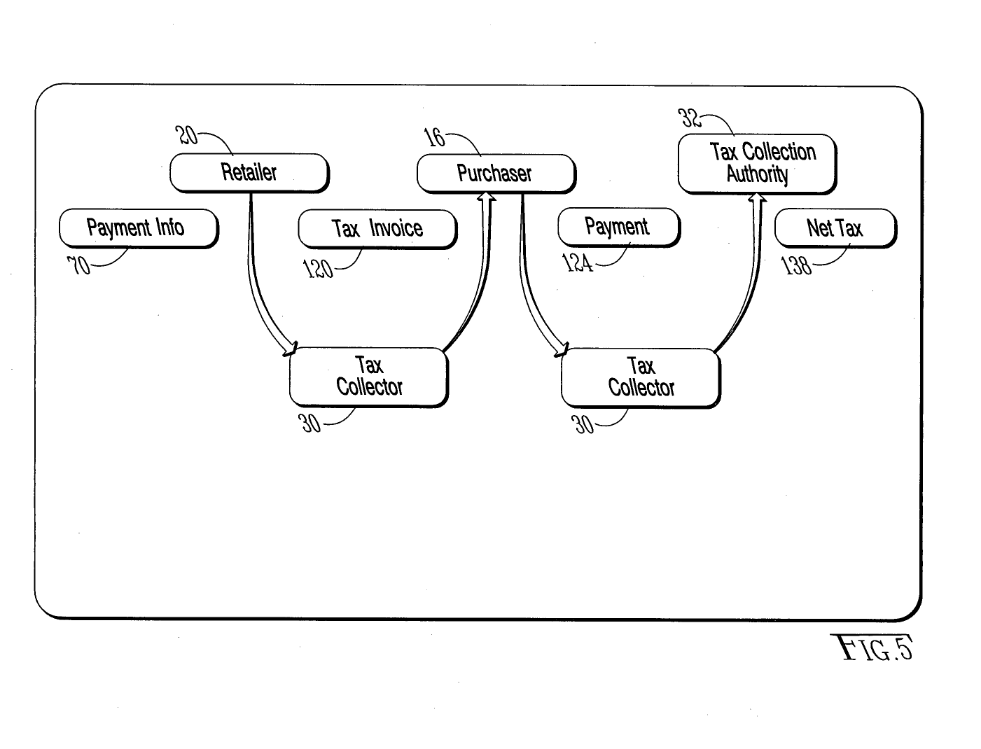

As shown in FIG. 5, according to an embodiment of the present invention, when a retailer (22) receives a purchase order (62) from a purchaser (16), the retailer (22) collects payment information (70) associated with the purchase order (62) for the tax collector (30). The retailer (22) periodically transmits this payment information (70) to the tax collector (30). The retailer (22) may transmit this information immediately, daily, weekly, monthly or whenever the tax collector (30) requires tax information to be submitted. The tax collector (128) may be an agent acting for several states or jurisdictions, or a subcontractor of such an agent or of a state. The tax collector (30) uses the tax collection software (100) to calculate whether tax is due on the purchase and, if so, transmits a tax invoice (120) directly to the purchaser (16). The purchaser (16) then transmits payment (124) back to the tax collector (30). The tax collector (30) then uses the payment information (70) to determine to which state tax collection authority (32) or (34) to remit the net tax (138). (FIGS. 1, 2 and 5). Alternatively, the state may require all of the payment information (70) be provided directly to the state and the state then provides the payment information (70) to the tax collector (30). As noted above, the net tax (138) may be the same as the payment (124). Alternatively, depending on the arrangement with the state tax collection authorities (32) and (34), the tax collector (30) may withhold an amount of the payment (124) to compensate the tax collector (30) for the calculation, collection and remittance functions associated with the system (10).

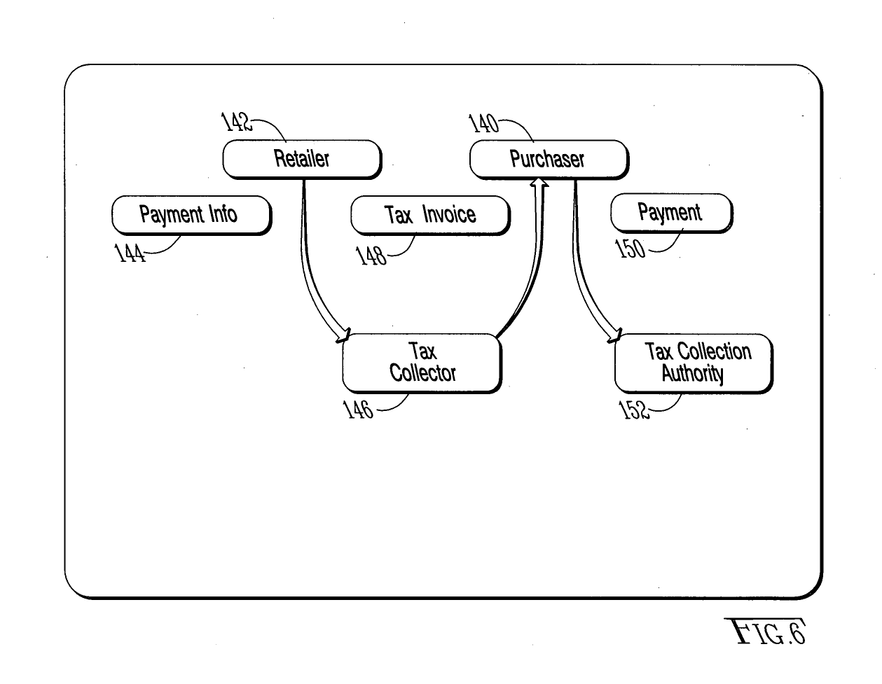

An alternative embodiment of the present invention is shown in FIG. 6 in which upon receipt of a purchase order, a retailer (142) submits payment information (144) to a tax collector (146) in a manner such as that described above. The tax collector (146) calculates the tax due, if any, based upon the payment information (144) and submits a tax invoice (148) back to the purchaser (140) along with payment forwarding instructions. Instead of transmitting the payment (150) back to the tax collector (146), as noted in the above embodiment, in this embodiment the purchaser (140) follows the payment forwarding instructions and submits the payment (150) directly to the state tax collection authority (152) or other designee of the state tax collection authority (152). In this embodiment, the tax collector (146) uses the payment information (144) to determine the appropriate state tax collection authority (152) to which the payment (150) must be submitted and includes that payment forwarding information with the tax invoice (148), allowing the purchaser (140) to remit the payment (150) directly to the state tax collection authority (152).

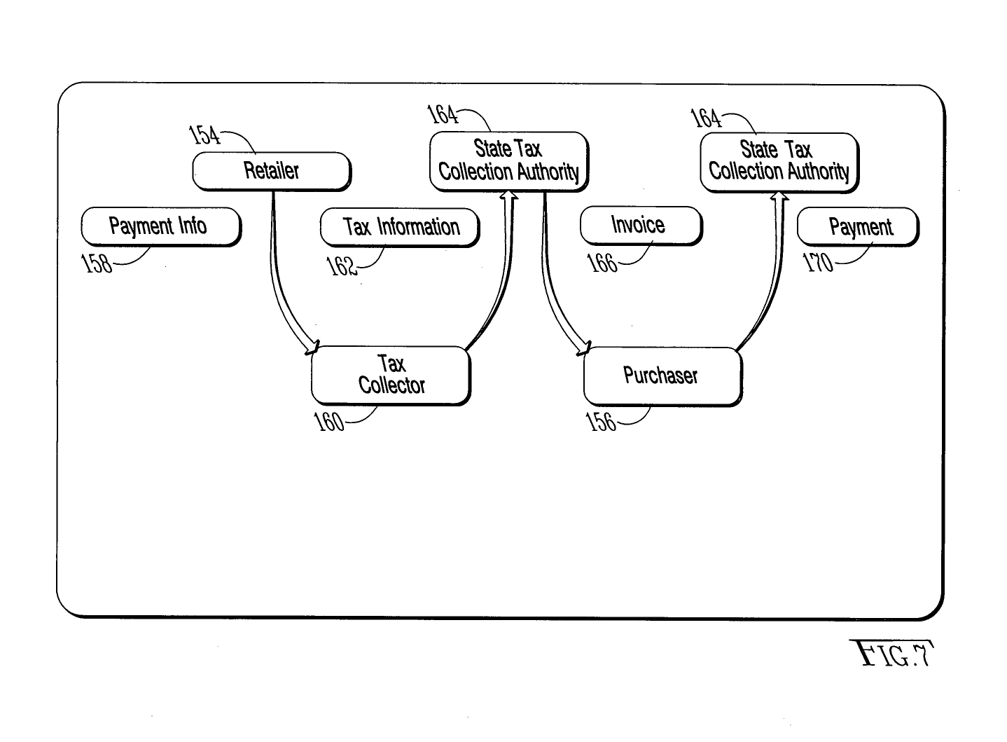

Another embodiment of the present invention is shown in FIG. 7. In this embodiment, after the retailer (154) receives a purchase order from a purchaser (156), the retailer (154) transmits the payment information (158) associated with the purchaser (156) to the tax collector (160) which uses the payment information (158) to calculate if and how much tax is due relative to the associated purchase order. If tax is due, the tax collector (160) forwards the information (162) to the appropriate state tax collection authority (164), which uses the information (162) to send an invoice (166) to the purchaser (156). Upon receipt of the invoice (166), the purchaser (156) remits payment (170) back to the state tax collection authority (164) or its designated recipient.

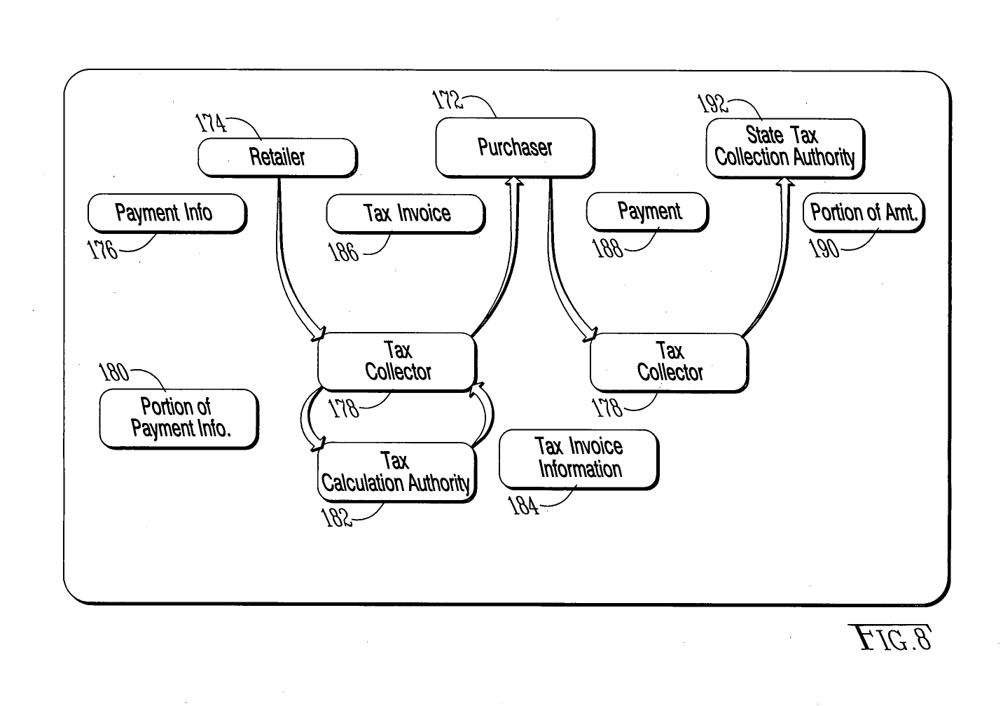

Shown in FIG. 8 is another alternative embodiment of the present invention that, upon receipt of a purchase order from a purchaser (172), a retailer (174) submits payment information (176) to a tax collector (178). The tax collector (178), in turn, submits the payment information (176), or a portion thereof (180) to a calculation authority (182), such as a certified service provider, as described above. The calculation authority (182) thereafter returns tax invoice information (184) to the tax collector (178). The tax collector (178) uses this tax invoice information (184) to prepare a tax invoice (186) and forward the tax invoice (186) to the purchaser (172). Thereafter, the purchaser (172) submits payment (188) of the invoice (186) to the tax collector (178), which returns all or a portion (190) of the payment (188) to the state tax collection authority (192) or its designated agent.

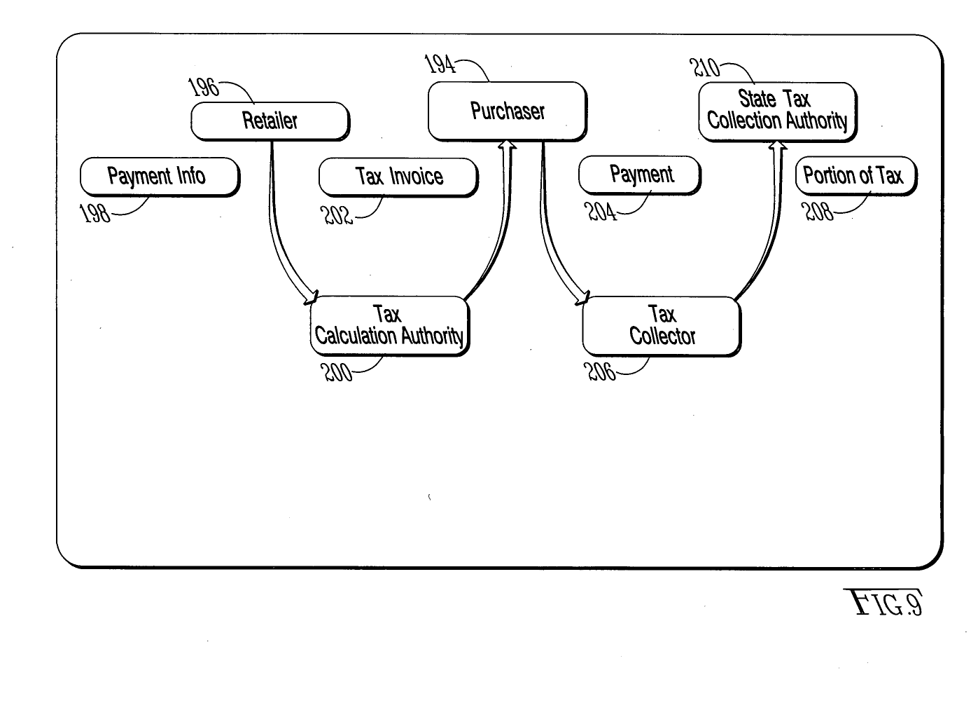

As shown in FIG. 9, when a purchaser (194) completes a purchase order with a retailer (196), the retailer (196) transmits data (198) relating to the purchase order to a collection authority (200). The collection authority (200) uses the data (198) to produce a tax invoice (202) that the collection authority (200) submits to the purchaser (194). The purchaser (194) thereafter submits payment (204) associated with the tax invoice (202) to a tax collector (206) that submits either the entire payment or a portion (208) thereof to the state tax collection authority (210).

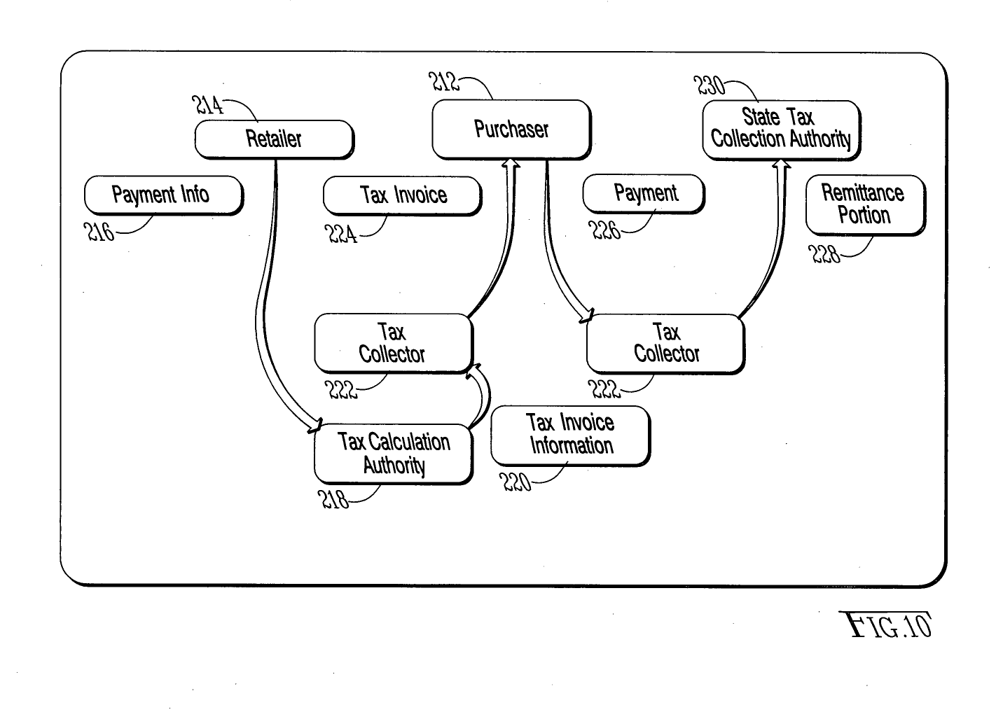

Another alternative embodiment of the present invention is shown generally in FIG. 10. Upon receipt of a purchase order from a purchaser (212), a retailer (214) transfers payment information (216) associated with the purchase order to a calculation authority (218). The calculation authority (218) uses the payment information (216) to generate tax invoice information (220) based upon tax rates and jurisdictional information previously obtained. The calculation authority (218) transfer the tax invoice information (220) to a tax collector (222). The tax collector (222) generates a tax invoice to (224) from the tax invoice information (220) and forwards the tax invoice (224) to the purchaser (212). The purchaser (212) then makes a payment (226) associated with the tax invoice (224) to the tax collector (222). The tax collector (222) then remits the payment or a portion (228) thereof to the associated state tax collection authority (230).

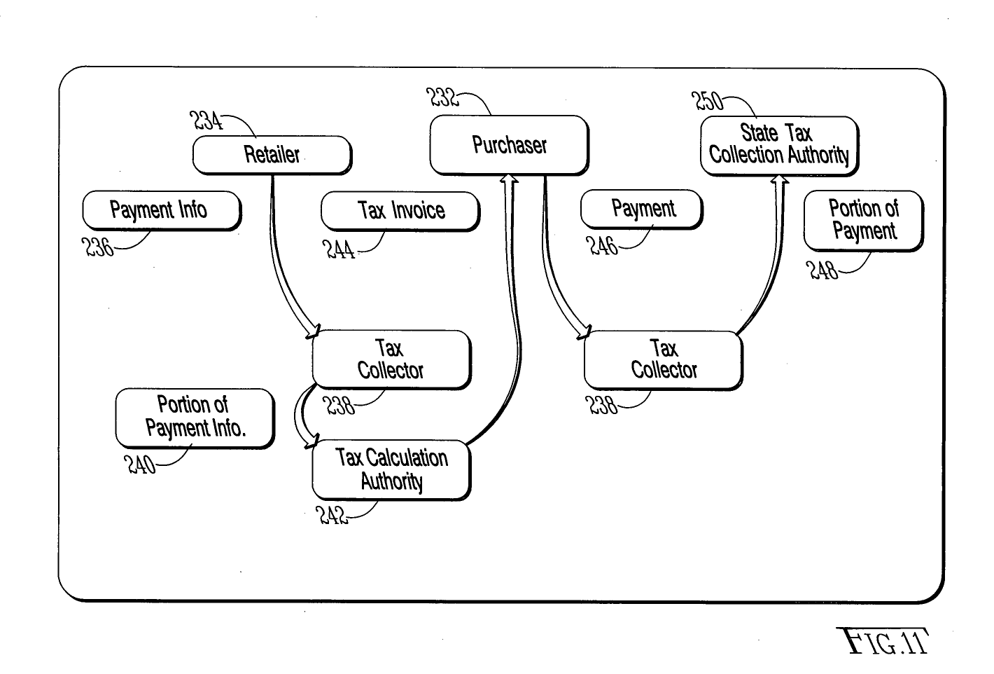

Another embodiment of the present invention is shown generally in FIG. 11. Upon receipt of a purchase order from a purchaser (232), a retailer (234) transmits payment information (236) associated with the purchaser (232) to a tax collector (238). The tax collector (238) thereafter transmits the payment information (236) or a portion (240) thereof to a calculation authority (242). The calculation authority (242) uses the payment information (236) or portion (240) thereof to produce a tax invoice (244) which the calculation authority (242) transmits to the purchaser (232). The purchaser (232) thereafter remits payment (246) of the tax invoice (244) to the tax collector (238). The tax collector (238) thereafter remits the payment (246) or a portion (248) thereof to the appropriate state tax collection authority (250) or its designated agent.

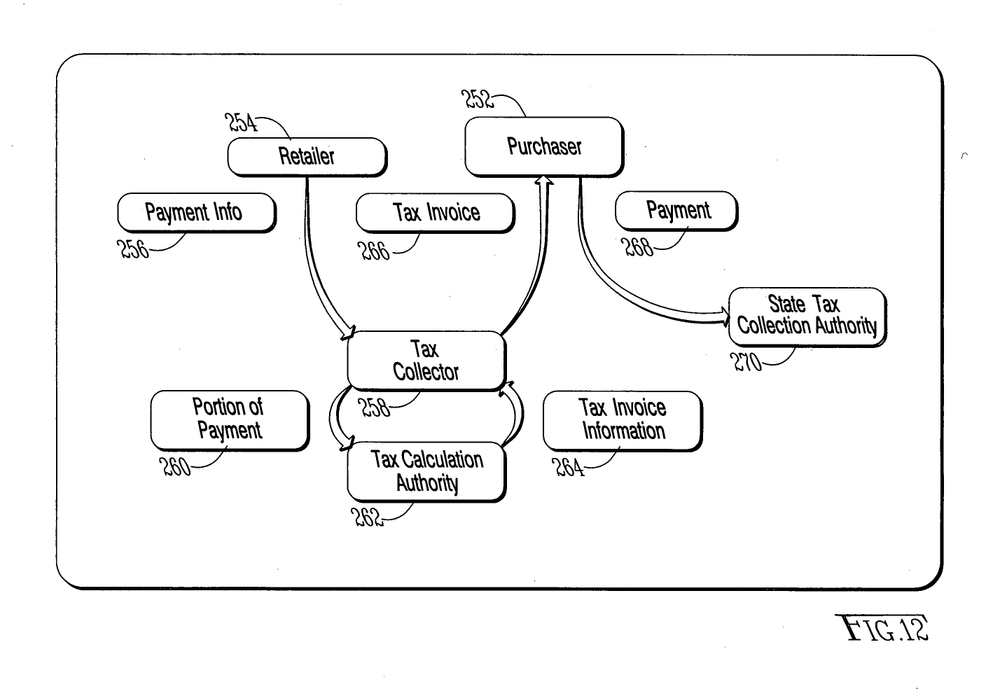

FIG. 12 shows another embodiment of the present invention in which after receipt of a purchase order from a purchaser (252), a retailer (254) transmits payment information (256) associated with the purchase order to a tax collector (258). The tax collector (258) submits the payment information (256) or a portion (260) thereof to a calculation authority (262) which uses the payment information (256) or portion (260) thereof to produce tax invoice information (264) that the calculation authority (262) transmits to the tax collector (258). The tax collector (258) thereafter generates a tax invoice (266) based on the tax invoice information (264) which it sends to the purchaser (252). The purchaser (252) thereafter remits payment (268) directly to the appropriate state tax collection authority (270) or its designated agent.

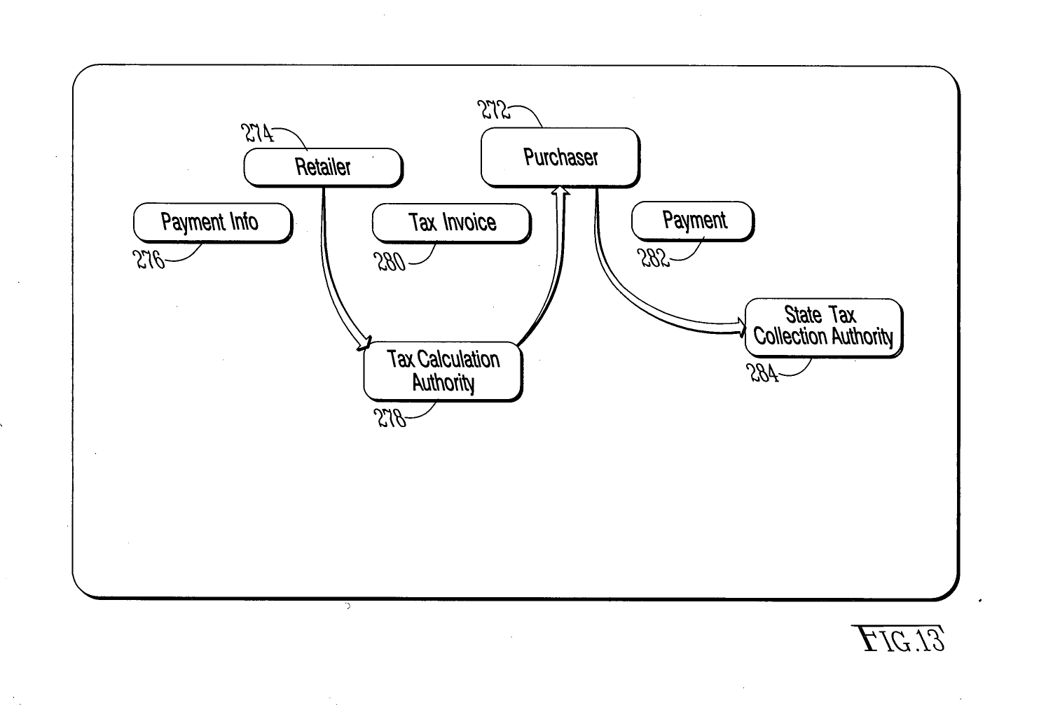

Another alternative embodiment of the present invention is shown in FIG. 13 in which upon receipt of a purchase order from a purchaser (272), a retailer (274) submits payment information (276) to a tax calculation authority (278) that uses the payment information (276) to produce a tax invoice (280) which it transmits to the purchaser (272). The purchaser (272) remits payment (282) directly to the state tax collection authority (284) or its designated agent.

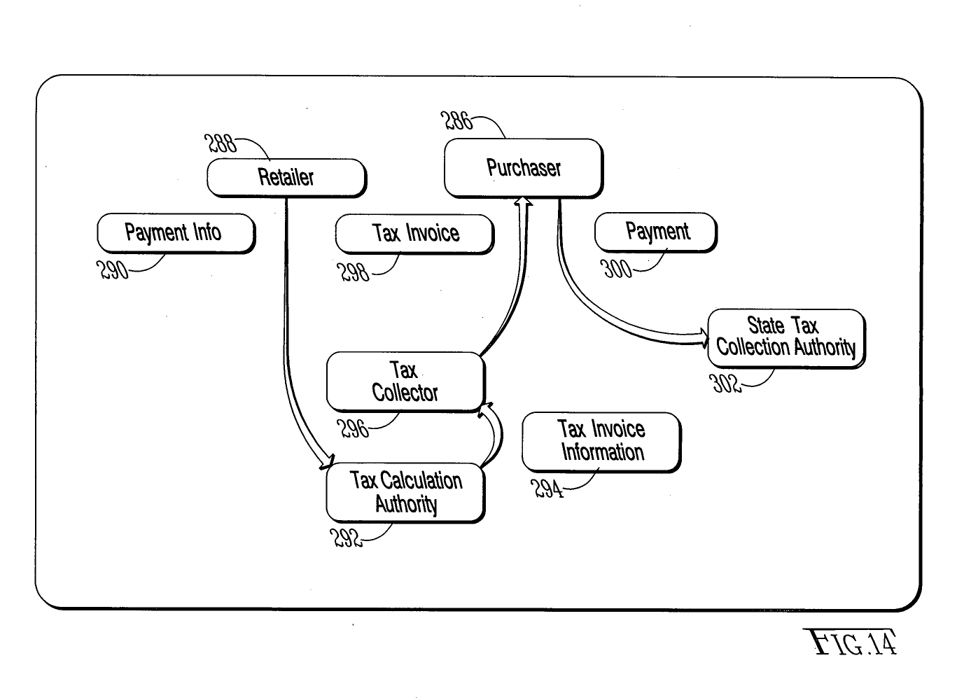

As shown in FIG. 14, an alternative embodiment of the present invention, upon receipt of a purchase order from a purchaser (286), a retailer (288) submits payment information (290) to a purchaser a tax calculation authority (292). The calculation authority (292) generates tax invoice information (294) based upon the payment information (290) and transmits the tax invoice information (294) to the tax collector (296). Using the tax invoice information (294) the tax collector (296) generates a tax invoice (298) which it transmits to the purchaser (286). The purchaser (286) thereafter remits payment (300) directly to the state tax collection authority (302) or its designated agent.

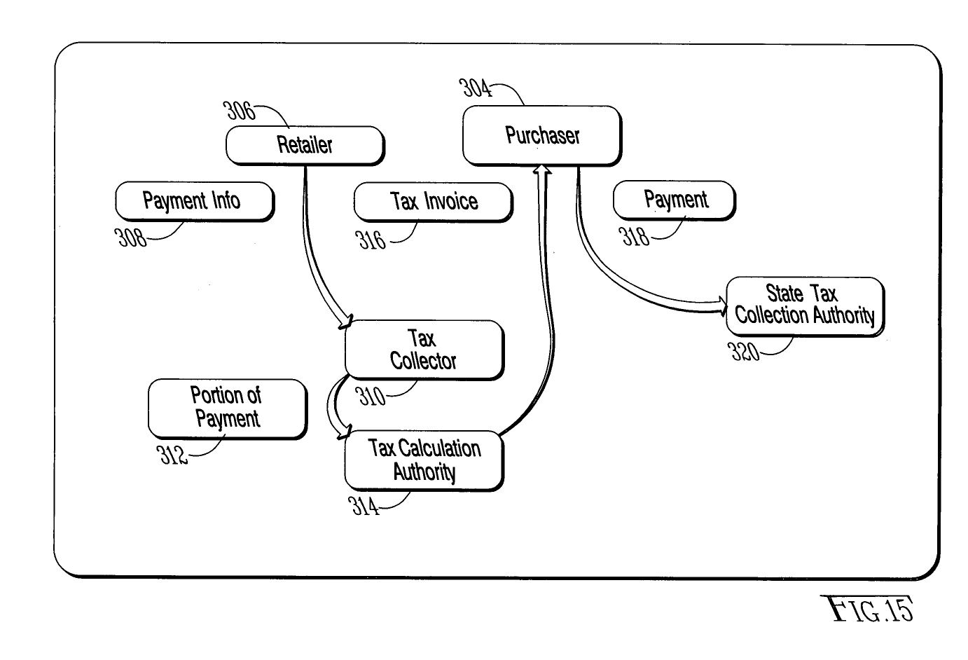

Another embodiment of the present invention is shown in FIG. 15 where upon receipt of a purchase order from a purchaser (304), a retailer (306) submits payment information (308) associated with a purchase order tax collector (310). The tax collector (310) submits either the payment information (308) or a portion (312) thereof to a tax calculation authority (314). The calculation authority (314) then generates a tax invoice (316) that is provided to the purchaser (304). The purchaser (304) thereafter remits payment (318) of the tax invoice (316) directly to the state tax collection authority (320) or its designated agent.

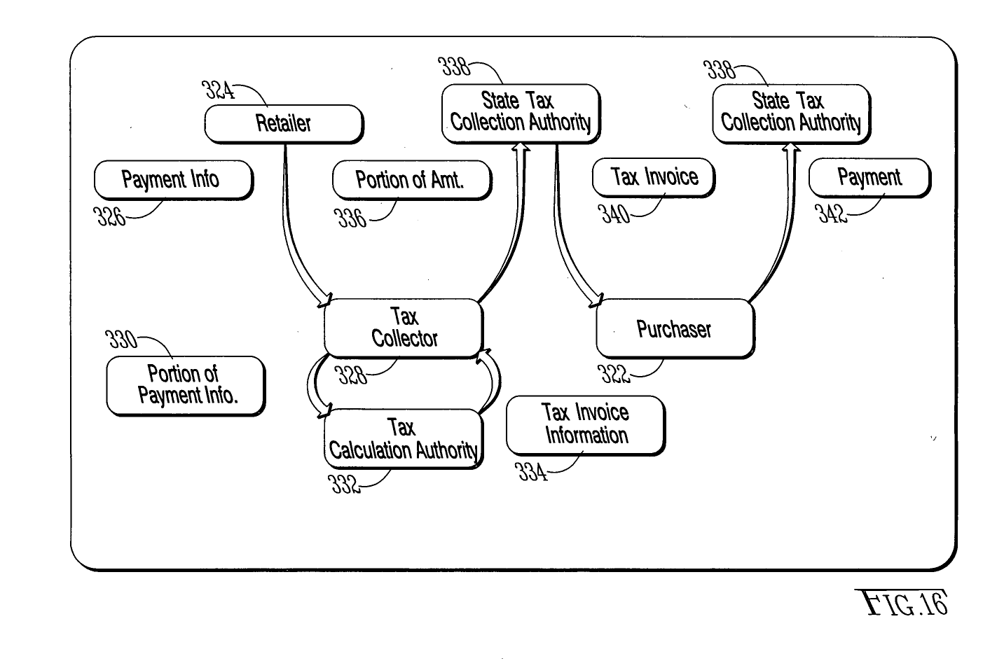

Another embodiment of the present invention is shown in FIG. 16 in which after receipt of a purchase order from a purchaser (322), a retailer (324) submits payment information (326) associated with the purchase order to a tax collector (328). The tax collector (328) submits the payment information (326) or a portion (330) thereof to a tax calculation authority (332), which uses this information to generate tax invoice information (334) which it supplies back to the tax collector (328). The tax collector (328) passes this information (334), or a portion (336) thereof, to the appropriate state tax collection authority (338). The state tax collection authority (338) uses this information to produce a tax invoice (340) which the state tax collection authority (338) transmits to the purchaser (322). The purchaser (322) then makes a payment (342) of the tax invoice (340) back to the state tax collection authority (338).

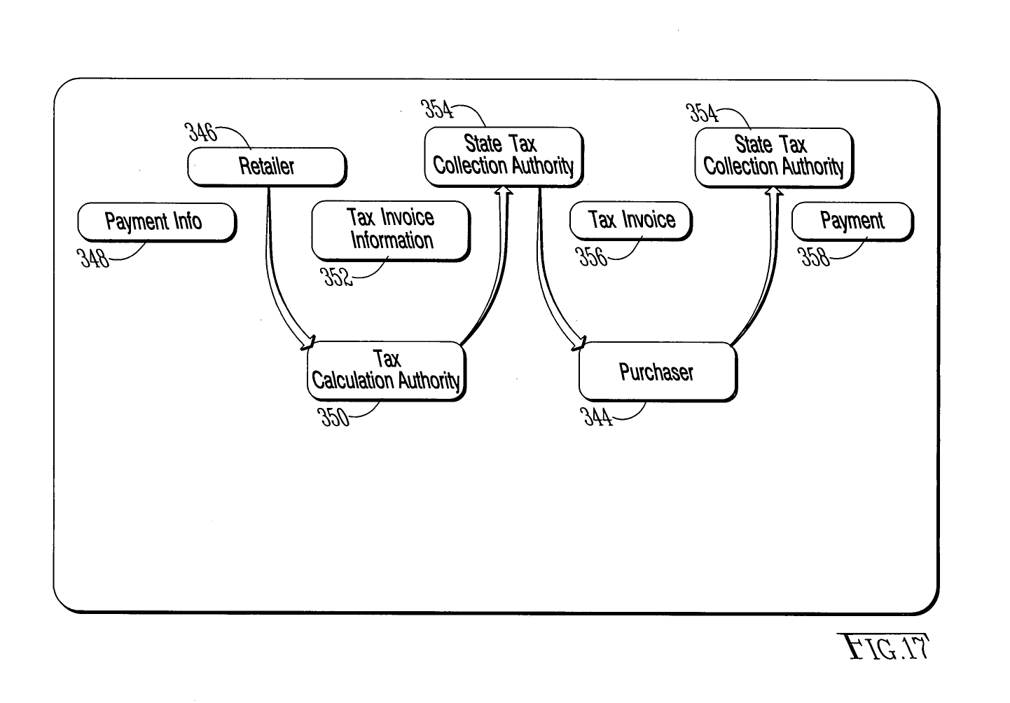

As shown in FIG. 17, upon receipt of a purchase order from a purchaser (344), the retailer (346) transmits payment information (348) associated with the purchase order to a tax calculation authority (350) that uses this information to generate a tax invoice or tax invoice information (352) which it submits to a state tax collection authority (354). The state tax collection authority (350) uses this information to generate a tax invoice (356) that the state tax collection authority (354) submits to the purchaser (344). The purchaser (344) then remits payment (358) of the tax invoice (356) back to the state tax collection authority (354).

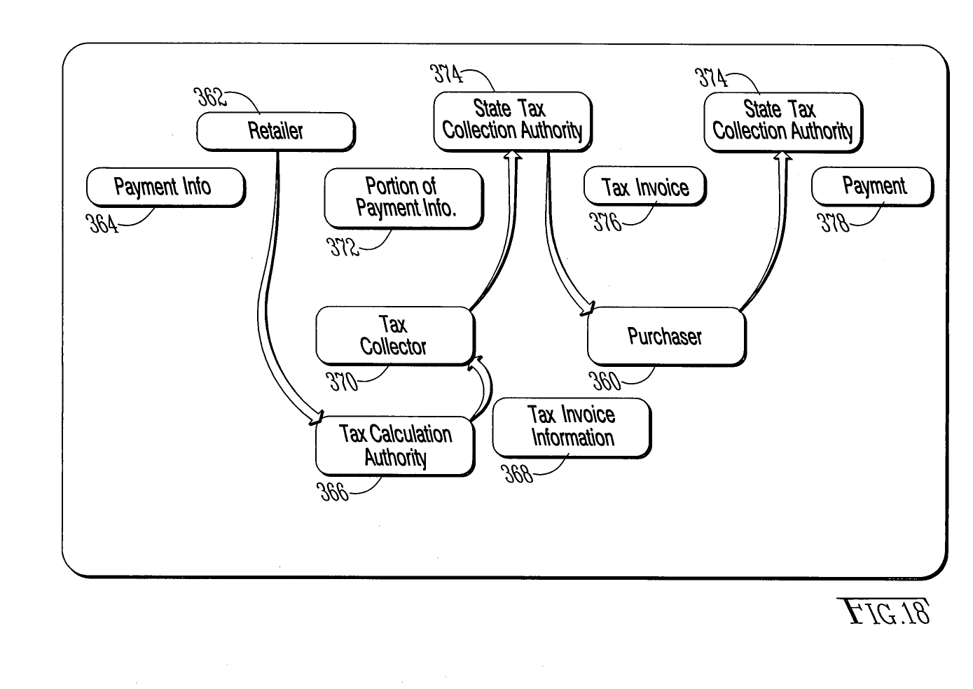

In still another embodiment of the present invention is shown in FIG. 18 in which upon receipt of a purchase order from a purchaser (360), a retailer (362) transmits payment information (364) associated with the purchase order to a tax calculation authority (366) which uses this information to generate tax invoice information (368) which it transmits to a tax collector (370). The tax, collector (370) either submits the tax invoice information (368) or a portion (372) thereof to the state tax collection authority (374). The state tax collection authority (374) uses this information to generate a tax invoice (376) that it submits to the purchaser (360). Upon receipt of the tax invoice (376), the purchaser (360) remits payment (378) of the tax invoice (376) to the state tax collection authority (374).

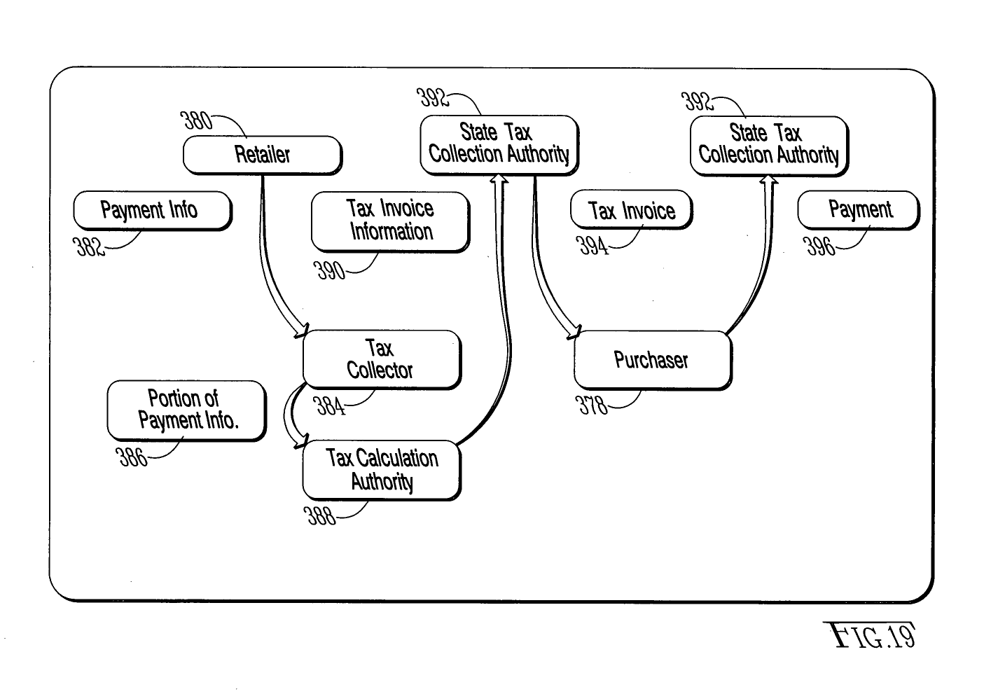

Another alternative embodiment of the present invention is shown in FIG. 19. Upon receipt of a purchase order from a purchaser (378), the retailer (380) submits payment information (382) associated with a purchase order to a tax collector (384). The tax collector (384) submits the payment information (382) or a portion (386) thereof to a tax calculation authority (388) that produces tax invoice information (390) that it supplies to the state tax collection authority (392). The state tax collection authority (392) uses the tax invoice information (390) to produce a tax invoice (394) that it submits to the purchaser (378). The purchaser (378) thereafter remits payment (396) to the state tax collection authority (392) or its designated agent.

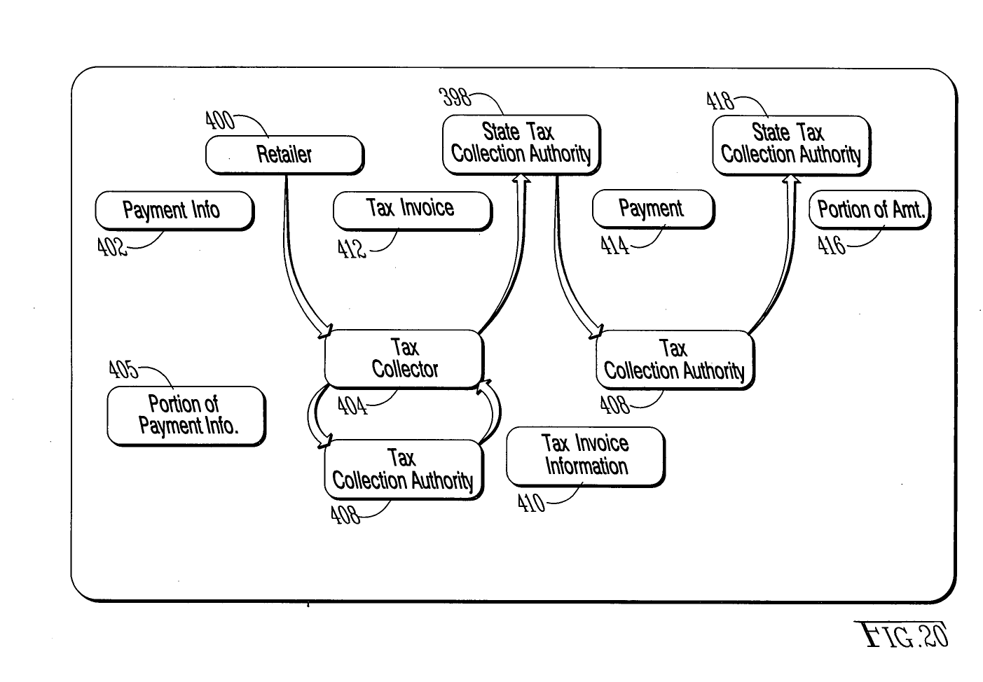

Another alternative embodiment of the present invention is shown in FIG. 20. Upon receipt of a purchase order from a purchaser (398) a retailer (400) submits payment information (402) associated with the purchase order to a tax collector (404). The tax collector (404) submits the payment information (402) or a portion (406) thereof to a tax calculation authority (408). The collection authority (408) calculates tax invoice information (410) from the portion (406) of payment information (402) and submits the tax invoice information (410) to the tax collector (404). The tax collector (404) uses the tax invoice information (410) to produce a tax invoice (412) that it submits to the purchaser (398). The purchaser (398) thereafter submits payment (414) of the tax invoice (412) to the collection authority (408) and the collection authority (408) transmits the payment (414) or a portion (416) thereof to a state tax collection authority (418) or its designated agent.

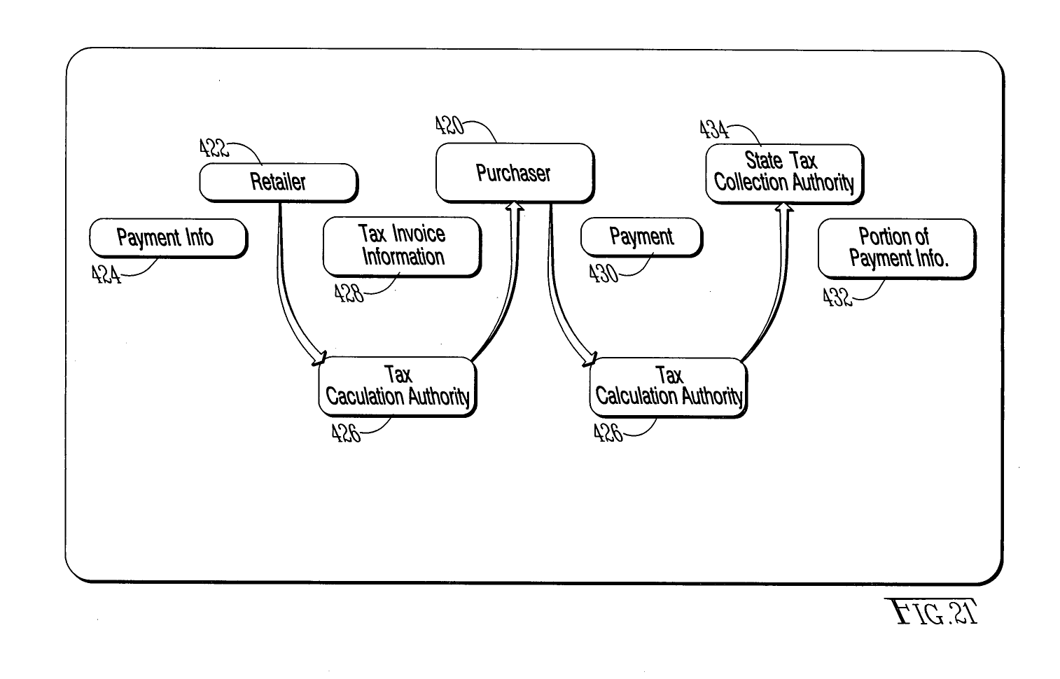

As shown in FIG. 21, an alternative embodiment of the present invention, upon receipt of a purchase order from a purchaser (420), a retailer (422) submits payment information (424) associated with the purchase order to a tax calculation authority (426). The tax calculation authority (426) uses this payment information (424) to produce a tax invoice (428) that it submits to the purchaser (420). The purchaser (420) then submits payment (430) of the invoice (428) to the tax calculation authority (426). The tax calculation authority (426) thereafter remits the payment (430) or a portion (432) thereof to the state tax collection authority (434) or its designated agent.

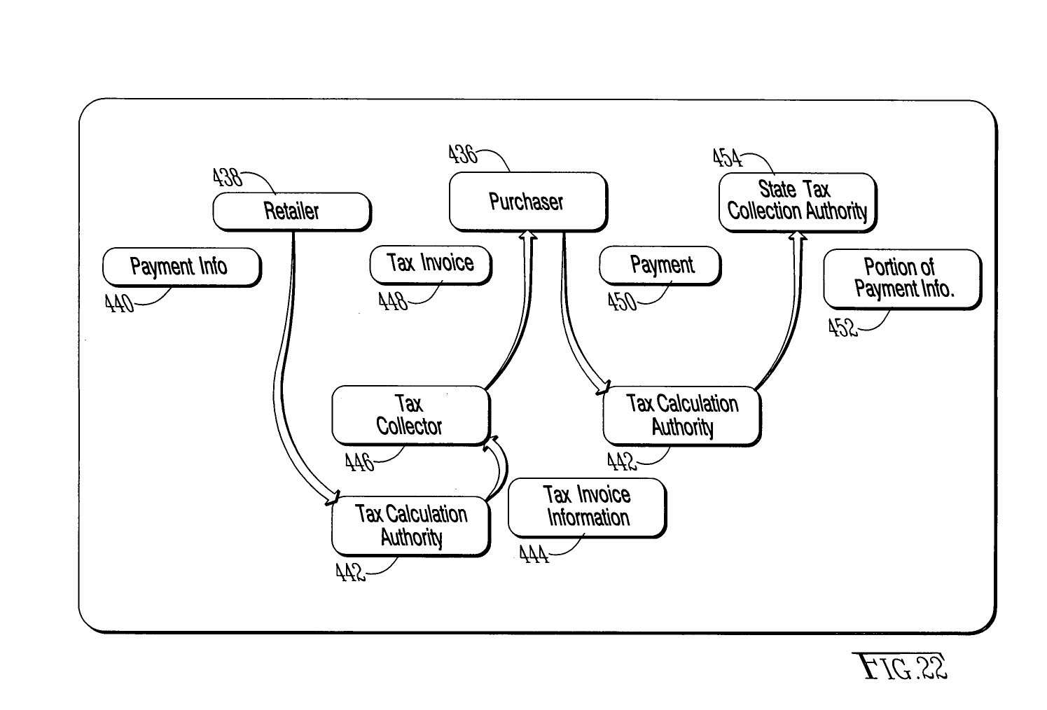

As shown in FIG. 22, an alternative embodiment of the present invention, upon receipt of a purchase order from a purchaser (436), a retailer (438) submits payment information (440) associated with the purchase order to a tax calculation authority (442). The tax calculation authority (442) uses the payment information (440) to produce tax invoice information (444) that it submits to a tax collector (446). The tax collector (446) thereafter uses the tax invoice information (444) to produce a tax invoice (448) that it submits to the purchaser (436). The purchaser (436) thereafter remits a payment (450) of the tax invoice (448) to the collection authority (442). The collection authority (442) either transmits the payment (450) or a portion (452) thereof to the state tax collection authority (454) or its designated agent.

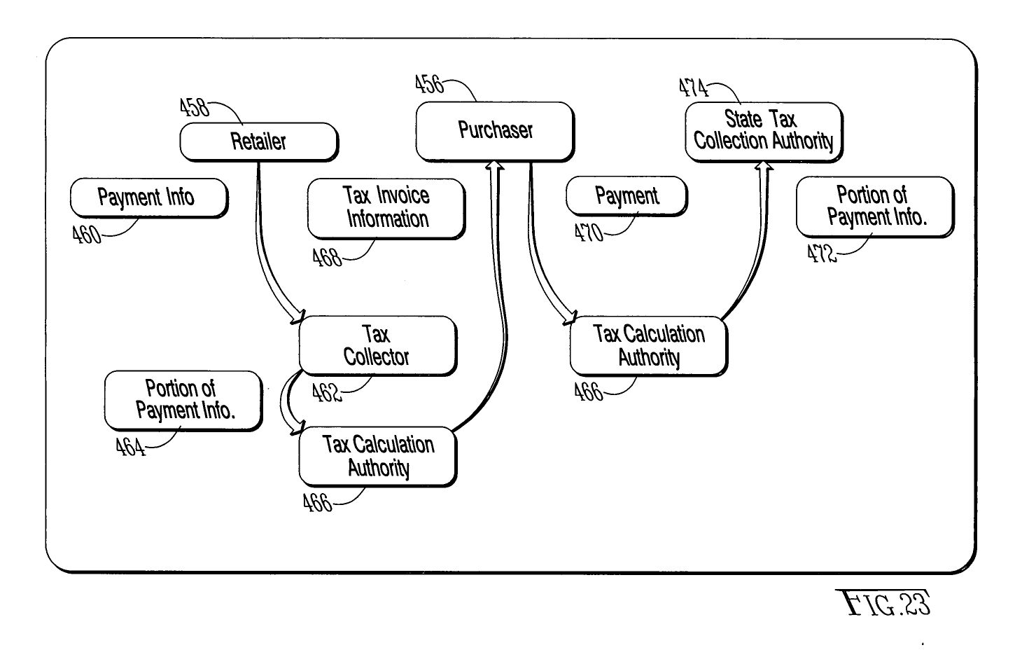

Yet another embodiment of the present invention is shown in FIG. 23. Upon receipt of a purchase order from a purchaser (456), a retailer (458) submits payment information (460) associated with the purchase order to a tax collector (462). The tax collector (462) either submits the payment information (460) or a portion (464) thereof to a tax calculation authority (466). The tax calculation authority (466) uses the payment information (460) or portion (464) thereof to produce a tax invoice (468) which it submits to the purchaser (456). Upon receipt of the tax invoice (468) the purchaser (456) remits payment (470) of the tax invoice (468) to the collection authority (466). The collection authority thereafter either remits the payment (470) or portion (472) thereof to the state tax collection authority (474) or its designated agent.

Although the invention has been described with respect to a preferred embodiment thereof, it is to be understood that it is not to be so limited since changes and modifications can be made therein which are within the full, intended scope of this invention as defined by the appended claims. As an example, although description in the preferred embodiment refers to states, the system (10) may be used between countries, municipalities, counties or in any other desired multijurisdictional environment or combination thereof.

What is claimed is:

1. A method comprising:
(a) providing an electronic communication system;
(b) executing a purchase order by a purchaser from a seller via the electronic communication system;
(c) providing a first payment associated with the purchase order from the purchaser to the seller via a first transaction via the electronic communication system;
(d) providing a purchaser identification to the seller via the electronic communication system;
(e) providing a purchase associated with the purchase order to the buyer;
(f) providing information associated with the purchase;
(g) providing the purchaser identification to the tax collector;
(h) calculating a tax assessment associated with the purchase order;
(i) communicating a tax invoice from the tax collector to the purchaser wherein the tax invoice comprises the tax assessment;
(j) collecting a second payment from the purchaser associated with the tax assessment via a second transaction, wherein the second transaction is discrete from the first transaction; and
(k) providing at least a portion of the second payment to a tax collecting authority.

2. The method of claim 1, further comprising associating a geographic region with the purchase wherein providing the second payment to a tax collecting authority comprises providing the second payment to a regional tax collecting authority associated with the geographic region.

3. The method of claim 1, wherein the electronic communication system is a telephony system;

4. The method of claim 1, the electronic communication system is a computer network.

5. The method of claim 1, the tax collecting authority is a state.

6. The method of claim 1, the purchase is a product.

7. The method of claim 1, the purchase is a service.

8. The method of claim 1, wherein the purchase comprises providing a good to an entity designated by the purchaser.

9. The method of claim 1, wherein the purchase comprises providing a service to an entity designated by the purchaser.

10. The method of claim 1, the computer network is a global communications network.

11. The method of claim 1, wherein providing the purchase associated with the purchase order to the seller comprises physically delivering a tangible product to the purchaser.

12. The method of claim 1, wherein providing the second payment to the tax collecting authority comprises providing the second payment via a government tax return.

13. The method of claim 1, the tax collector is the tax collecting authority.

14. The method of claim 1, further comprising:
(a) executing a supplemental purchase order by the purchaser from a supplemental seller via the computer network;
(b) providing a third payment associated with the supplemental purchase order from the purchaser to the supplemental seller via a third transaction via the computer network;
(c) providing a supplemental purchase associated with the supplemental purchase order to the seller;
(d) providing information associated with the supplemental purchase to the tax collector;
(e) calculating a supplemental tax assessment associated with the supplemental purchase;
(f) incorporating the supplemental tax assessment into the tax invoice; and
(g) wherein the second payment includes funds associated with the supplemental tax assessment.

15. The method of claim 1, further comprising providing the second payment at least one hour after providing the first payment.

16. The method of claim 15, further comprising preventing the first payment from commingling with the second payment.

17. A method comprising:
(a) providing a global computer network;
(b) executing a first purchase order by a purchaser from a first seller via the global computer network;
(c) providing a first payment associated with the purchase order from the purchaser to the first seller via a first transaction via the global computer network;
(d) providing a purchaser identification to the first seller via the global computer network;
(e) providing a first purchase associated with the first purchase order to the buyer;
(f) providing information associated with the first purchase to a tax collector;
(g) providing the first purchaser identification to the tax collector;
(h) calculating a first tax assessment associated with the first purchase order;
(i) executing a second purchase order by the purchaser from the first seller via the global computer network;
(j) providing a second payment associated with the purchase order from the purchaser to the first seller via a second transaction via the global computer network;
(k) providing the purchaser identification to the first seller via the global computer network;
(l) providing a second purchase associated with the second purchase order to the buyer;
(m) providing information associated with the second purchase to a tax collector;
(n) providing the second purchaser identification to the tax collector;
(o) communicating a tax invoice from the tax collector to the purchaser wherein the tax invoice comprises the first tax assessment and the second tax assessment;
(p) collecting a third payment from the purchaser associated with the first tax assessment and the second tax assessment; and
(q) providing at least a portion of the third payment to a tax collecting authority.

18. The method of claim 17, further comprising providing the second payment at least one hour after providing the first payment.

19. The method of claim 17, wherein the third payment comprises commingled funds associated with the first tax assessment and the second tax assessment.

20. A method comprising:
(a) providing a global computer network;
(b) executing a first purchase order across at least one state line by a purchaser from a first seller via the global computer network;
(c) providing a first payment associated with the purchase order from the purchaser to the first seller via a first transaction via the global computer network;
(d) providing a purchaser identification to the first seller via the global computer network;
(e) providing a first purchase associated with the first purchase order to the buyer;
(f) providing information associated with the first purchase to a tax collector;
(g) providing the first purchaser identification to the tax collector;
(h) calculating a first tax assessment associated with the first purchase order;
(i) executing a second purchase order across at least one state line by the purchaser from a second seller via the global computer network;
(j) providing a second payment associated with the purchase order from the purchaser to the first seller via a second transaction via the global computer network;
(k) providing the purchaser identification to the first seller via the global computer network;
(l) providing a second purchase associated with the second purchase order to the buyer;
(m) providing information associated with the second purchase to a tax collector;
(n) providing the second purchaser identification to the tax collector;
(o) communicating a tax invoice from the tax collector to the purchaser wherein the tax invoice comprises the first tax assessment and the second tax assessment;
(p) collecting a third payment from the purchaser associated with the first tax assessment and the second tax assessment;
(q) providing at least a portion of the third payment to a tax collecting authority
(r) wherein the purchaser is subject to first use tax laws associated with a first state;
(s) wherein the first seller is subject to second use tax laws associated with a second state;
(t) wherein the second seller is subject to third use tax laws associated with a third state;
(u) wherein the first state, the second state and the third state are different states; and
(v) wherein the tax collecting authority is associated with the first state.
